(19) United States
(12) Patent Application Publication
(10) Pub. No.: US 2003/0088991 A1
(43) Pub. Date: May 15, 2003

(54) Single-side measuring devices and methods

(76) Inventor: Larry W. Fullerton, Brownsboro, AL (US)

Correspondence Address: MICHAEL E. WOODS, 104 COLLINS STREET, SAN FRANCISCO, CA, 94118, US

(21) Appl. No.: 10/045,610

(22) Filed: Nov. 9, 2001

(51) Int. Cl. G01B 5/08

(52) U.S. Cl. 33/555.1

(57) ABSTRACT

A variety of measuring devices are provided for determining a radius of a work piece having a substantially circular cross-section without contacting opposing sides of the work piece. A guide portion includes a first side and a second side which contact two points of the work piece. A probe measures a distance to the work piece. In some embodiments, the first and second sides of the guide portion form a Vee and the probe is disposed in the vertex of the Vee. In some embodiments, the first side of the guide portion may be moved relative to the second side in order to accommodate a wide range of work piece sizes.

### BACKGROUND OF THE INVENTION

This invention relates generally to radius of curvature measurement devices and particularly to a device allowing such measurement from one side of an object having a substantially circular cross-section.

### DESCRIPTION OF RELATED ART

The radius of curvature of objects, especially cylinders, is commonly measured by direct measurement of the diameter, using a micrometer or similar device. Such devices typically measure the distance between two parallel components contacting the test article on opposite sides, using either mechanical or electronic means.

While this method is very accurate, it has the disadvantage of requiring simultaneous access to opposing sides of the test article. This is disadvantageous in various contexts, such as machining operations in which the article must be accessed by one or more machining and supporting tools while monitoring the radius.

An example of this problem in the automotive industry is the need to grind the journals of a crankshaft to very fine tolerances on the order of 0.0001 inch. Conventionally, this is done by moving a grinding wheel in to remove some metal from a journal of a spinning crankshaft, then moving the wheel back and stopping the crankshaft to examine the new diameter by placing a caliper in contact with opposing sides of the journal. The process is repeated until the desired diameter is achieved. This iterative process can take a very long time to complete for all 16 journals on a typical crankshaft because the grinding process cannot continue while a journal is being measured.

One method that has been tried with some success is to place a dial indicator that is anchored to the bed of the grinder, against the shaft, to measure the progress. However, this method is very inaccurate because the shaft flexes during grinding more than the final desired tolerance. An accurate method of measuring the in-process diameter of a work piece is clearly very desirable.

Sometimes it is difficult or impossible to access the opposing sides of a test article to measure its diameter with a caliper style instrument. For example, quality control measurements and inventory assessments of tubular stock are often hampered by lack of access to opposing sides of the stock. Partially buried pipes—or installed and partially exposed pipes—do not normally permit access to opposing sides of the pipe. In such instances, direct measurement is impossible using a caliper style instrument, forcing the radius to be estimated using the length and depth of a chord. This estimation is time consuming even if the circular cross section is exposed. If the cross section is obscured, accurate measurement of an article's radius of curvature is nearly impossible.

### SUMMARY OF THE INVENTION

The present invention provides methods and devices for measuring a test article having a circular cross section without requiring access to either diametrically opposite sides of the test article or its cross section. Although these devices have varying geometries, they will sometimes be referred to herein as “V gauges” or “Vee gauges.”

In accordance with some embodiments of the present invention, a V gauge includes a length-measuring sensor (also referred to herein as a “probe”) and a V-shaped guide portion configured to receive a test article. When a test article, at least a portion of which has a circular cross section, is placed in contact with the sensor and the guide portion, the V gauge obtains a measurement proportional to the radius of the test article. This measurement may then be converted to useful measurement units using a proportionality constant that is a function of the angle of the V and the length measured by the sensor.

In some embodiments, the sensor is movable parallel to the radius of the test article. According to some embodiments of the present invention, the sensor includes a tip which may be rotated relative to a main portion of the sensor. In some such embodiments, the sensor includes a roller tip.

According to some embodiments of the present invention, the guide portion of the V gauge includes straight sides which form a constant angle. In some such embodiments, the guide portion comprises a first side and a second side, wherein the first side is fixedly attached to the second side. In some such embodiments, the guide portion comprises a first side and a second side, wherein the first side is movably attached to the second side. In some embodiments, the first side and the second side which may be separated or brought together to accommodate test pieces of differing radii.

According to some embodiments of the present invention, the guide portion of the V gauge forms a plurality of angles. In some such embodiments, the guide portion of the V gauge has straight sides with different angles at different distances from the vertex of the V gauge. In some embodiments, the guide portion of the V gauge has curved sides. In some such embodiments, the guide portion comprises a first side and a second side, wherein the first side is fixedly attached to the second side. In some such embodiments, the guide portion comprises a first side and a second side, wherein the first side is movably attached to the second side.

According to some embodiments of the present invention, the guide portion of the V gauge includes a first circular portion and a second circular portion, wherein each “circular portion” includes a surface formed from at least part of a circle. In some such embodiments, the first circular portion is attached to the second circular portion. In other embodiments, the first circular portion is movable relative to the second circular portion.

In some embodiments of the present invention, a V gauge is used in the feedback loop of an automatic control system to allow articles to be machined to size without operator intervention. In some such embodiments, the V gauge is mounted on a machining device (for example, a grinder) with means for developing a force directed toward the center of a test article having a circular cross section, thereby obtaining a measurement proportional to the radius of curvature of the article.

### BRIEF DESCRIPTION OF THE DRAWINGS

FIG. 1 is a schematic illustration of a device according to one embodiment of the present invention, shown measuring a test article.

FIG. 2 illustrates a special case wherein the diameter of a test article is equal to the length of the V gauge's probe.

FIG. 3 illustrates one embodiment of a straight-sided, constant-angled measuring device according to the present invention.

FIG. 4 depicts one embodiment of a curved-sided, variable-angled measuring device according to the present invention.

FIG. 5 depicts one embodiment of a straight-sided, variable-angled measuring device according to the present invention.

FIG. 6 illustrates an embodiment of a straight-sided, multiple-angled measuring device according to the present invention.

FIG. 7 illustrates a first position of an embodiment of a straight-sided V gauge in which the sides of the V can be separated.

FIG. 8 illustrates a second position of an embodiment of a straight-sided V gauge in which the sides of the V can be separated.

FIG. 9 illustrates a first position of an embodiment of V gauge in which the sides of the V are formed of rollers which can be separated.

FIG. 10 illustrates a second position of an embodiment of V gauge in which the sides of the V are formed of rollers which can be separated.

FIG. 11 is a schematic diagram which illustrates the theoretical basis for the V gauge shown in FIG. 9.

FIG. 12 is a schematic diagram which illustrates the theoretical basis for the V gauge shown in FIG. 10.

FIG. 13 illustrates a mechanism for maintaining contact between a V gauge and a work piece.

FIG. 14 depicts a first embodiment of a V gauge's probe and a tool bit within a machined portion of a work piece.

FIG. 15 depicts a second embodiment of a V gauge's probe and a tool bit within a machined portion of a work piece.

FIG. 16 illustrates a schematic view of a measuring device according to the present invention used in a feedback loop of an automatic control system that can machine articles to size without operator intervention.

FIG. 17 is a block diagram illustrating the connection between a measuring device according to the present invention, a machine tool and a processor used to control a feedback loop of an automatic control system.

FIG. 18 is a flow chart indicating a simplified version of a method for implementing an automatic control system for a single measurement.

FIG. 19 is a flow chart indicating a simplified version of a method for implementing an automatic control system for measurements at various portions of one or more work pieces.

FIG. 20 is an illustration of one embodiment of a device for coupling a probe and a gauge portion of a V gauge.

### DESCRIPTION OF THE SPECIFIC EMBODIMENTS

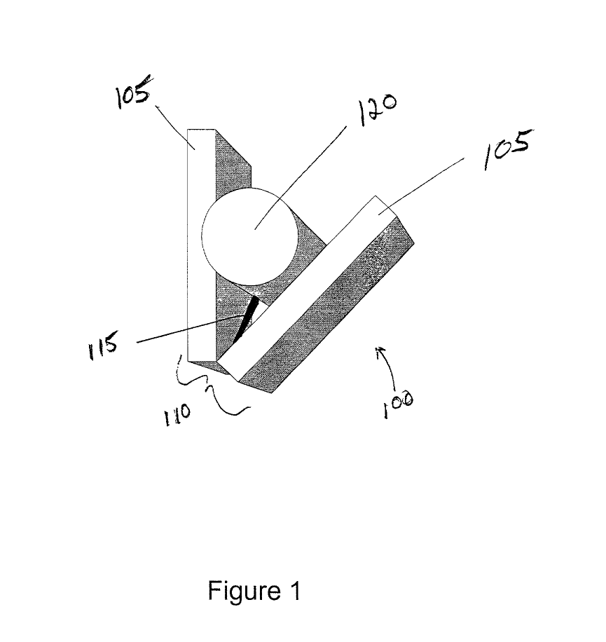

FIG. 1 is a perspective drawing showing the relative positions of sides 105 and probe 110 (also referred to herein as a “sensor”) of V gauge 100. Sides 105 form guide portion 110, within which test article 120 is positioned. Because test article 120 has a circular cross-section and is in contact with sides 105 and probe 110, the radius, diameter, circumference or cross-sectional area of test article 120 may readily be determined by V gauge 100. For the sake of brevity, this description will disclose how to calculate the diameter or radius of such a test article. However, one of skill in the art will readily appreciate that a cross sectional area A can be calculated using the formula A=πr² and circumference C can be calculated using the formula C=2πr.

Although the test articles illustrated herein will generally have entirely circular cross-sections, a V gauge can be used to measure test articles which do not have entirely circular cross-sections. For example, a V gauge can be used to measure a portion of an article which has a constant radius of curvature, for example, a semicircle or a rounded corner.

A V gauge could also measure the minimum and maximum “radii” of an ellipse, thereby determining the dimensions of the ellipse and the orientation of its major and minor axes. For example, the major axis will be perpendicular to the points on the circumference of the ellipse at which a minimum “radius” is measured. The foci lie on the major axis.

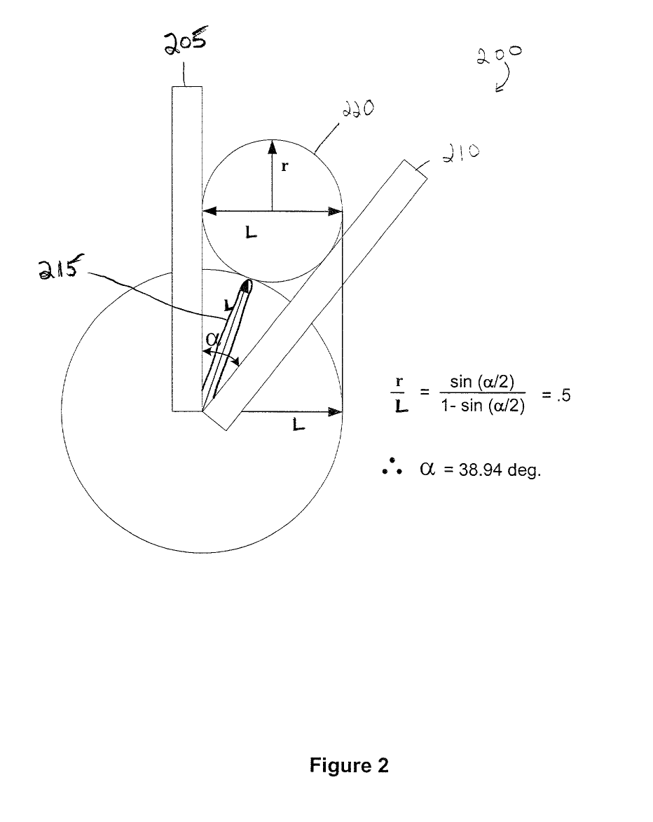

The theoretical basis for the present invention will first be explained with reference to FIG. 2. Sides 205 and 210 form an angle α within which test article 220 is positioned. Test article 220 has a radius r and is in contact with side 205, side 210 and probe 215, having length L, when test article 220 is being measured. V gauge 200 determines radius r according to the following equation:

$$\frac{r}{L} = \frac{sin ( α / 2 )}{1 - sin ( α / 2 )} \qquad ( Equation 1 )$$

FIG. 2 illustrates the special case wherein the diameter of the test article is equal to the distance from the vertex of the V to the surface of the article. In this case, a depth gauge placed at the vertex will indicate the actual diameter of the article. In other words, if it is desired to read out the diameter of an article directly, i.e., the length measured by the sensor is equal to the article's diameter, then the

$$\frac{r}{L}$$

ratio is set to 0.5 and the V angle α=38.94°. For an

$$\frac{r}{L}$$

ratio of 1, length L of probe 215 is exactly equal to radius r and the “V” angle α formed by the sides of the V gauge is equal to 60°.

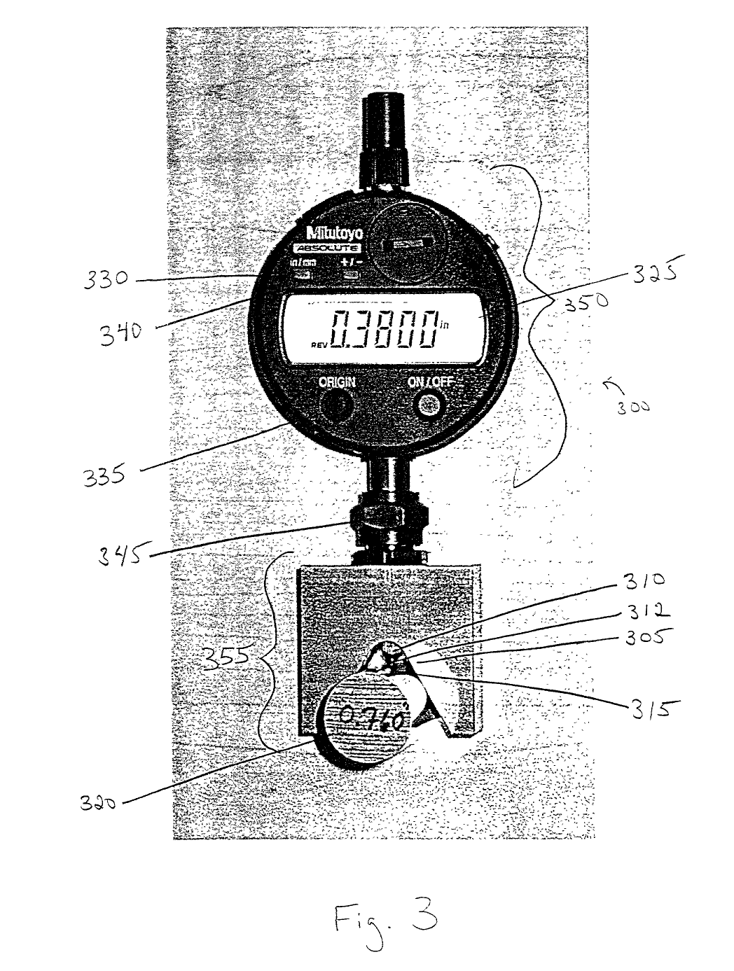

A hand-held embodiment of a measuring device according to the present invention is illustrated in FIG. 3. V gauge 300 includes sides 305 of guide portion 355, between which sensor 310 is disposed. Sensor 310 is in contact with side 315 of work piece 320, which in this example has a circular cross-section with a diameter of 0.760 inches. In the embodiment shown in FIG. 3, the length measured by sensor 310 is equal to the radius and the “V” angle α formed by the sides of the V gauge is equal to 60°.

In the embodiment shown in FIG. 3, sensor 310 includes a mechanical linkage to V portion 305 and length L is determined by the displacement of this linkage. Tip 312 of sensor 310 is formed by shaping one end of sensor 310 to a point [It doesn't actually have to be a point: it only needs to be convex with its tangent normal at its intersection with the probe axis]. However, in other embodiments of sensor 310, the friction between sensor 310 and work piece 320 is reduced by using a rolling surface for tip 312. For example, some embodiments of tip 312 include a ball bearing, mounted in a similar way to the ball in a ball point pen. Other embodiments of tip 312 include a roller bearing mounted with the axis of the bearing parallel to that of the work piece.

Other embodiments of sensor 310 include non-contact devices for measuring L, including but not limited to the following:

1. LVDT—A Linear Variable Differential Transformer is a cylindrical cavity surrounded by two transformer solenoids. A primary winding covers both coils and excites a core inside that causes the voltage seen by each of two secondaries to vary linearly as the core position changes, said core being mechanically coupled to the V probe. This voltage is multiplied by an appropriate value (depending on the type of V gauge, as set forth below) to convert that voltage into a measurement of the work piece.

2. Optical—Several methods involving light can be used. There are many optical distance measuring techniques known to the art, and most can be used in this application. These include interferometry, triangulation, focal intensity, depth of field, and echo ranging. Other optical techniques include CCD (Charge Coupled Device) and MOS (Metal Oxide Semiconductor) line and area sensors that can not only measure the distance to a point but also measure the profile of the work piece.

3. Ultrasonic and RF—These methods include echo ranging, interferometry and intensity measurements of reflected sound or light.

4. Capacitive—The proximity of a surface can be determined by measuring the capacitance of an air gap between the sensor and the work piece.

5. Eddy Current—The impedance imposed by a conductor to a nearby AC-excited inductor can be used to indicate distance.

In some embodiments, the foregoing alternative sensors are employed in the same direction as the axis of sensor 310. In other embodiments, such alternative sensors are employed in other directions. Some non-contact sensors may conveniently be operated in a direction perpendicular to the axis of sensor 310. In such embodiments, the position of work piece 320 may be determined by locating an edge of work piece 320 along which a signal from a first portion of the non-contact sensor to a second portion of the non-contact sensor is blocked by the work piece.

In the embodiment shown in FIG. 3, display 325 is a liquid crystal display (LCD) which provides a digital readout: in this case, the readout is the radius of work piece 320, displayed in inches. However, in other embodiments, the output of V gauge 300 may be any combination of direct reading, remote reading, mechanical read-out, electronic readout, electronic sensor to computer or machine tool feedback electronics, optical readout (visual markings), micrometer, limit switch to indicate correct size or a plurality of switches to indicate several sizes, light-emitting diodes (“LEDs”), plasma displays, or incandescent displays. The display may be numeric, alphanumeric, VU meter style output or any other convenient readout. For example, in some embodiments display 325 includes a dial indicator. In some such embodiments, sensor 310 is mechanically linked to the dial indicator.

Unit control 330 allows a user to change the display from British units to metric units. Origin control 335 clears display 325.

Polarity control 340 allows measurement of work piece 320 in a positive or negative direction along the axis of sensor 310, so that the direction of measurement may be reversed. In the embodiment shown in FIG. 3, the reading increases as sensor 310 increases in length. However, one method of monitoring the removal of material from a work piece involves the placement of the probe of a dial indicator against the work piece and providing a mount on the machine itself to hold the dial gauge steady and the V surfaces are in contact with the un-machined part of the work piece. In this mode, as material is machined from the work piece the distance between the surface and the stationary dial gauge is increased. Therefore, as the probe advances, the dial will indicate a decrease in diameter of the work piece directly, without the application of the proportionality constant needed in normal V gauge operation. However, as described below, preferred embodiments of the Vee gauge move with the work piece as the material is removed, and allow the work piece to fall farther into the Vee as it is machined, thereby causing the indicator the probe to be retracted rather than extended. Such a reverse-reading dial gauge in this latter case will indicate the radius directly when a flat surface Vee is used with an angle of 60° and will indicate diameter directly when an angle of 38.94° is used.

Attaclunent member 345 secures gauge assembly 350 to guide portion 355. In the embodiment shown in FIG. 3, attachment member 345 includes a hexagonal nut. However, in other possible embodiments attachment member 345 includes by way of example and not exclusively an arbor chuck, a screw thread, a bayonet (which is particularly advantageous for quick changes) and/or a screw fastener.

In the embodiment shown in FIG. 3, attachment member 345 secures gauge assembly 350 to guide portion 355 such that one will not move relative to the other. In other embodiments, attachment member 345 allows at least a part of guide portion 355 to move relative to gauge assembly 350. In some embodiments, attachment member 345 includes a ball bearing assembly or similar device for allowing gauge assembly 350 to be rotated about at least one axis. In some such embodiments, gauge assembly 350 may be locked into place (for example, by a nut, pin, latch, or similar mechanism) after being rotated to a desired position. In other embodiments, some of which will be described below, attachment member 345 allows sides 305 to move relative to one another.

The materials used to construct sides 305 and sensor 310 can be important, especially when the V gauge is used as a precision instrument, because the tolerance of the unit will be compromised if any of the surfaces wear due to rubbing mechanical contact. Examples of materials that will perform well for industrial and other commercial use include chromium-plated and surface-hardened steel. If precision is less important (e.g., in lower-cost models intended for mass markets), sides 305 and sensor 310 can be made of plastic, especially if the plastic is reasonably hard and has a low coefficient of friction. Alternative low cost designs can be fabricated from sintered metal. This material is reasonably durable and may also be impregnated with oil to make it a low friction surface, as is commonly done in so-called oilite bearings.

The accuracy of V gauge 300 is a function of the slope of the r/L formula at the point of measurement, i.e., dr/dL. A flat-faced Vee gauge with a large angle will not cause as great a change of reading with a change of work piece diameter as would one with a smaller angle. Since any sensor technology has a basic sensitivity (i.e., output change/input change) below which it is considered to be inaccurate, it is desirable to present the smallest dr/dL to the sensor that is practical within the context of the application and cost constraints.

It is possible to construct a Vee gauge sensor so that it is automatically calibrated by using careful manufacturing processes. However, in practice it is generally easier and cheaper to calibrate it after final assembly. In the case of a basic Vee with straight surfaces and a fixed angle, it can be calibrated by inserting a known diameter cylinder and setting the output to that known value. If the angle of the V is also a variable, such as with low cost designs, two measurement with 2 different diameter cylinders are necessary. If roller bearings or stationary circular Vees are used (such as those described below), then two measurements are needed to calibrate the V gauge, which can be accomplished by inserting two cylinders of known diameter and entering their value.

If both the angle and the spacing of the sides are varied, two measurements are generally required to re-calibrate the V gauge. This can be accomplished by using two different sized cylinders. Either the dimensions of these cylinders must be previously known or their dimensions must be entered when the calibration is performed. Calibration accuracy increases with larger differences between the calibrating cylinders.

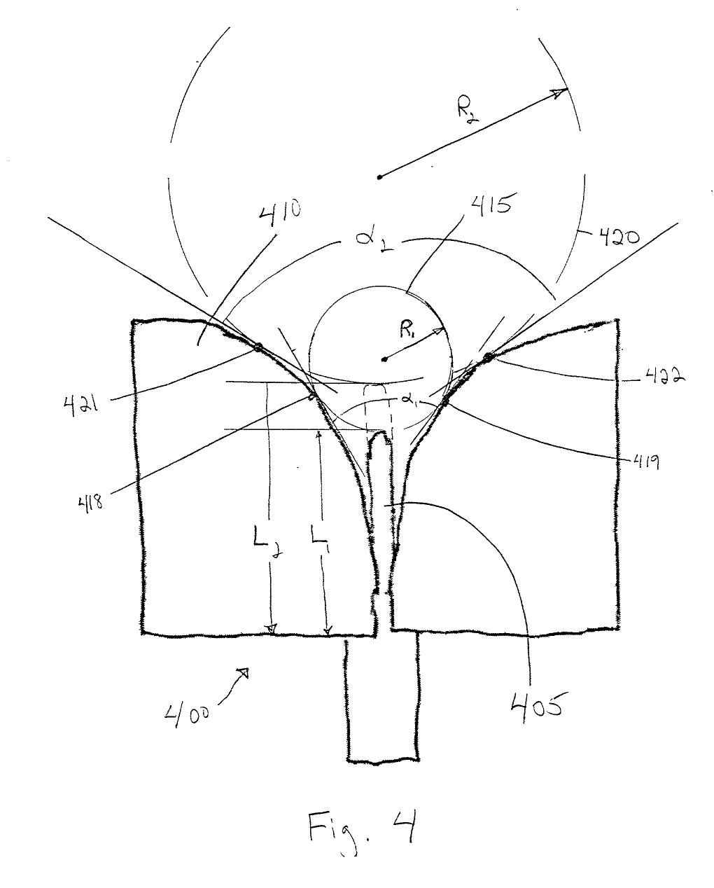

The V gauge of the present invention includes a variety of embodiments for accommodating a wide range of work piece radii. For example, FIG. 4 illustrates V gauge 400, which includes probe 405 disposed between sides 410. Work piece 415 has radius R₁ and contacts sides 410 at points 418 and 419. Work piece 420 has radius R₂, which is substantially larger than radius R₁. However, work piece 420 contacts sides 410 at points 421 and 422, which are relatively close to points 418 and 419, respectively. It may be seen from FIG. 4 that a wide range of work piece radii could be measured by a single V gauge 400, depending on the curvature of sides 410.

It may be seen that as probe 405 is moved from a first position in contact with work piece 415 to a second position in contact with work piece 420, both the length L of probe 405 and angle α change. In the example shown in FIG. 4, L₁<L₂ and α₁<α₂. Therefore, Equation (1) cannot be used without modification for V gauges with arbitrarily curved faces. Instead, there are alternative methods for determining the radius of the work piece when used with such V gauges.

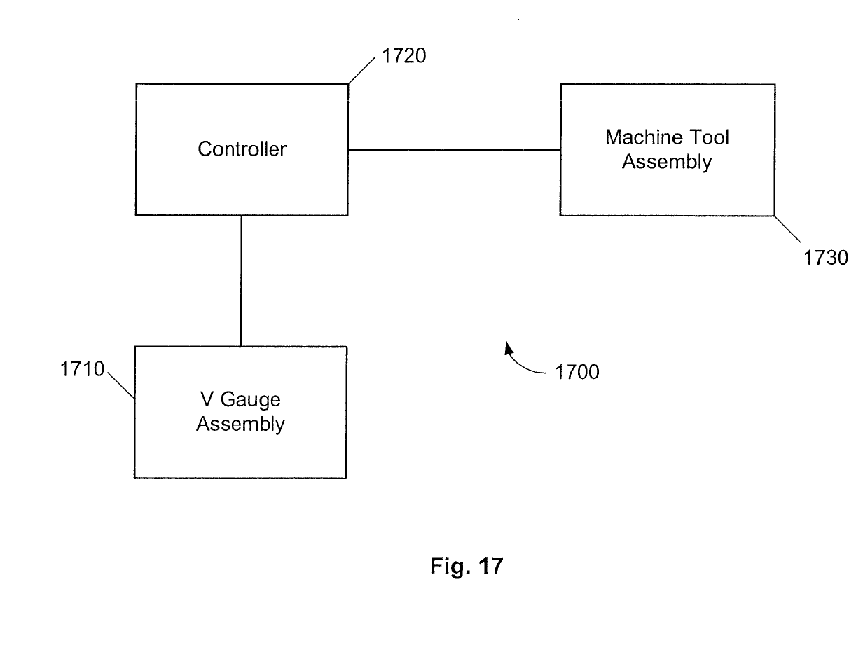

In one such alternative method, the values of work piece radii corresponding to various values of L are determined in advance and stored in a table. The radii may be determined analytically, by direct measurement or by numerical analysis. In some such embodiments, the table is stored in a memory accessible to a processor which receives values of L and determines the corresponding work piece radii. One exemplary processor is controller 1720, which will be described below with reference to FIG. 17. In other such embodiments, the table is referenced by a user who determines the radii corresponding to measured values of L.

In other methods, the values of work piece radii corresponding to various values of L are calculated each time a new value of L is measured. The radii may be determined analytically or by numerical analysis. In preferred embodiments, the calculation is performed by a processor such as controller 1720.

In theory, the condition of three points of contact can be met for a work piece of any size using V gauge 400, but the accuracy of the measurement may be reduced as the diameter of the work piece is increased. Larger diameter Vee curves will extend the accuracy to larger work pieces, however. By using a cam or the like it is possible to vary the sensitivity of the probe at the same rate that the circular curves decrease such sensitivity. If done accurately, the accurate measurement range of diameters could be substantially increased while using simple linear sensors to make the measurement of L.

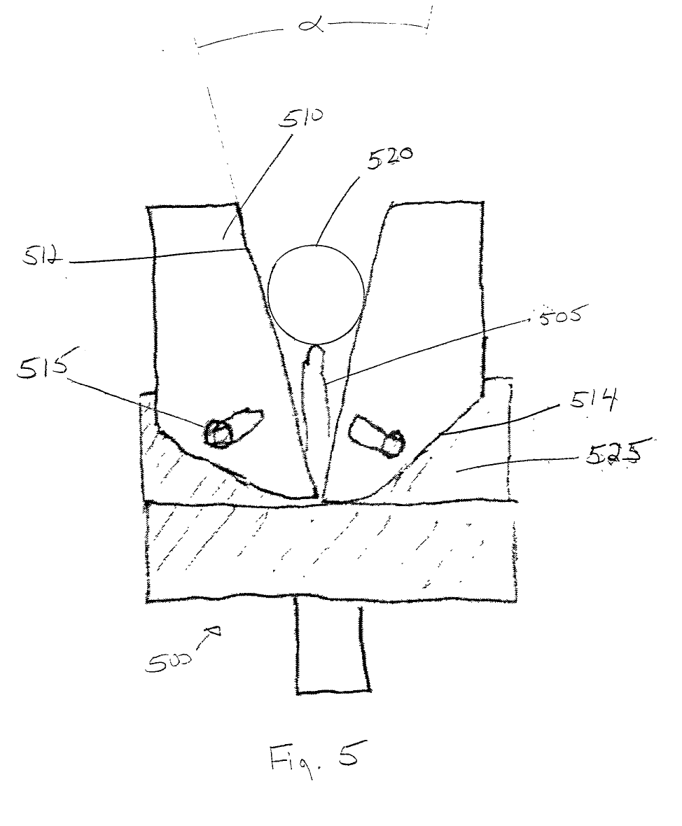

FIG. 5 illustrates V gauge 500, which may be positioned in a range of angles α. Probe 505 is disposed between V portions 510, which are straight on sides 512 facing work piece 520 and curved on sides 514 which face base 525. Curved sides 512 allow sides 512 to be positioned in a range of angles α and adjustment devices 515 allow sides 512 to be fixed in desired angles α. In the embodiment shown in FIG. 5, adjustment devices 515 are screws, but any convenient adjustment devices 515 may be used, such as bolts, gears, ratchets, pins, etc.

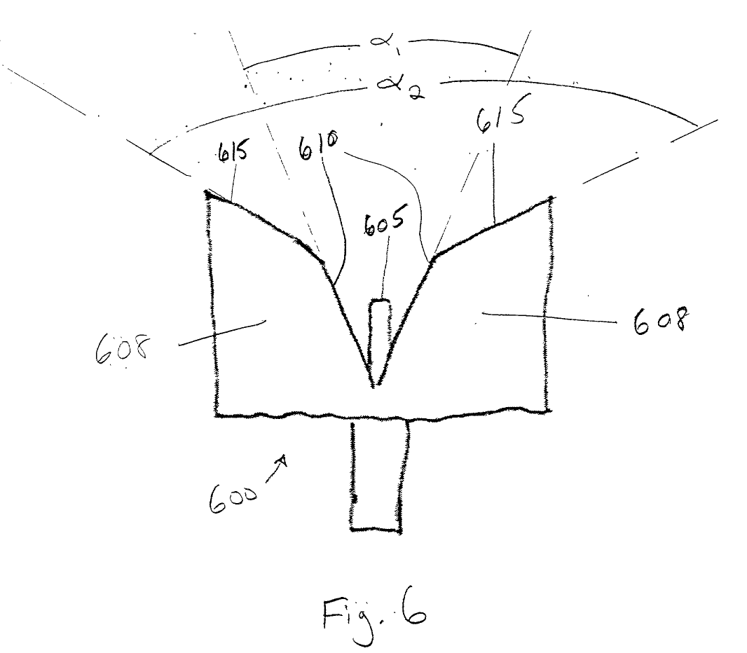

FIG. 6 illustrates an embodiment of V gauge 600, which includes sensor 605 disposed between V portions 608. Sides 610 form angle α₁ with respect to one another, and sides 615 form angle α₂ with respect to one another. Accordingly, V gauge 600 is configured to accommodate a wide range of work piece radii.

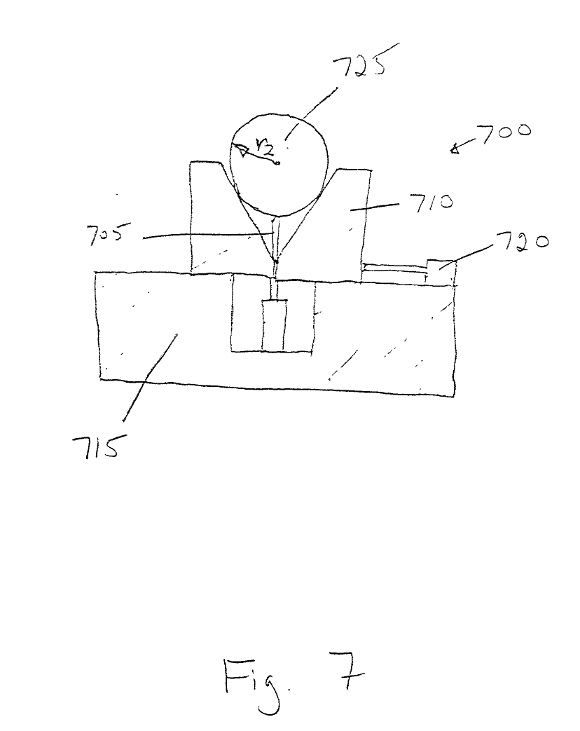

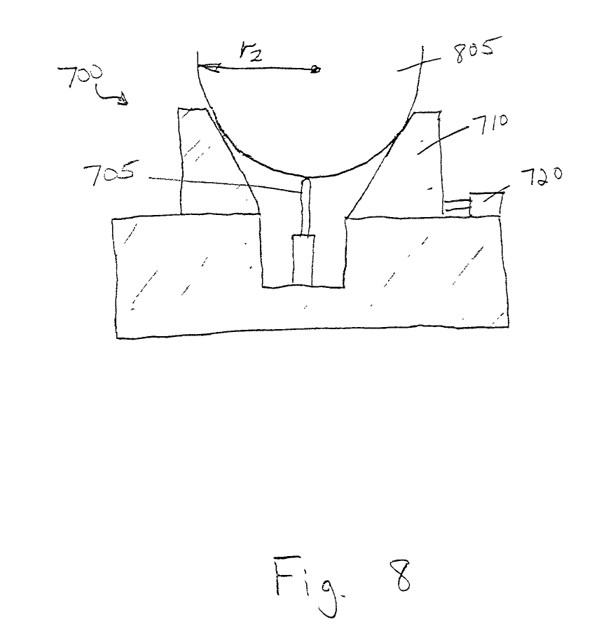

V gauge 700, depicted in FIGS. 7 and 8, is another device for accommodating a wide range of work piece sizes. FIG. 7 illustrates V gauge 700 in a first position for measuring relatively smaller work piece 725, which is situated between sides 710 and atop sensor 705. Sides 710 are slidably attached to base 715 and maybe moved in the plane of the drawing by motor 720. For example, in one embodiment sides 710 are moved by means of a screw with opposing threads so that the two sides move in opposite directions to each other.

FIG. 8 illustrates V gauge 700 in a second position for measuring relatively larger work piece 805. Motor 720 has pulled sides 710 apart to allow work piece 805 to contact sides 710 and sensor 705, thereby allowing work piece 805 to be measured by V gauge 700.

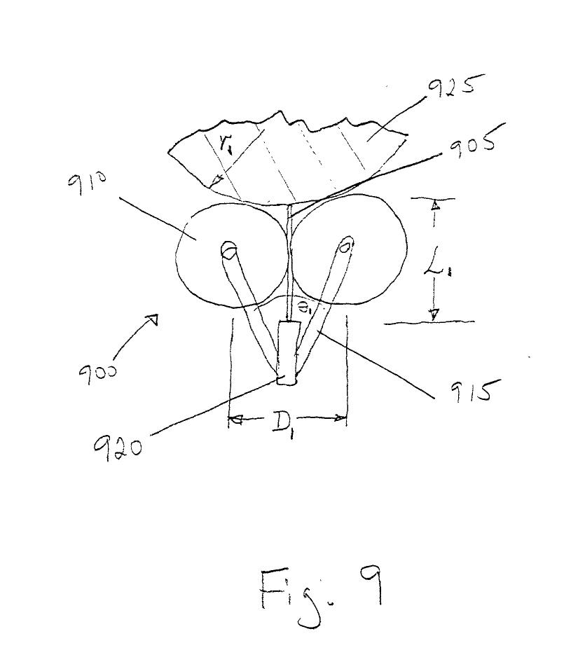

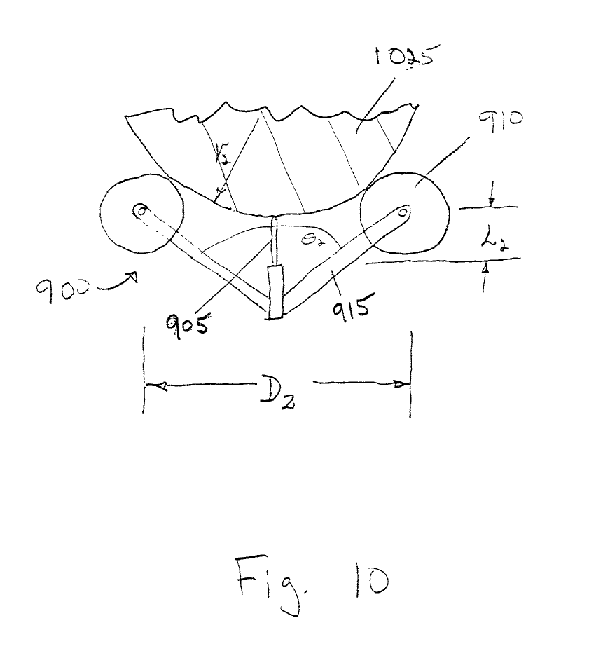

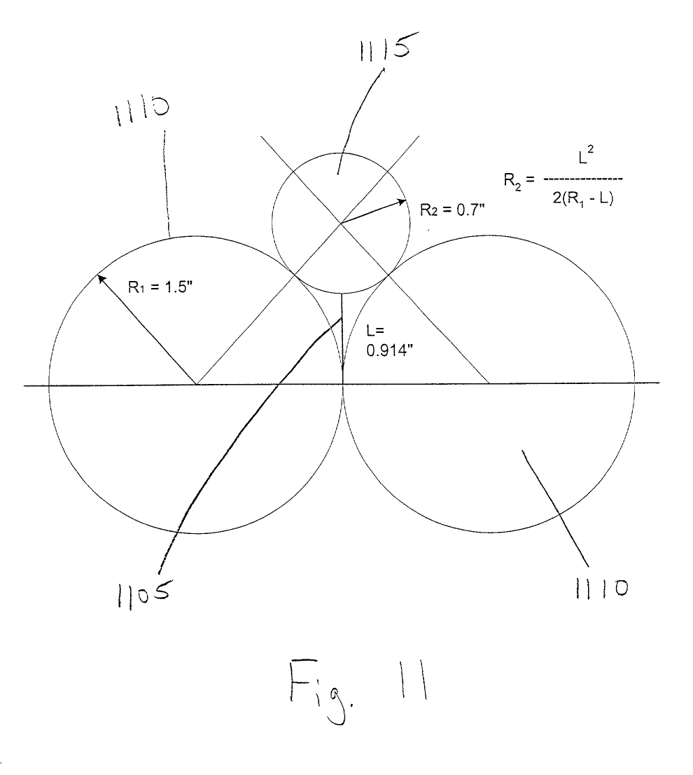

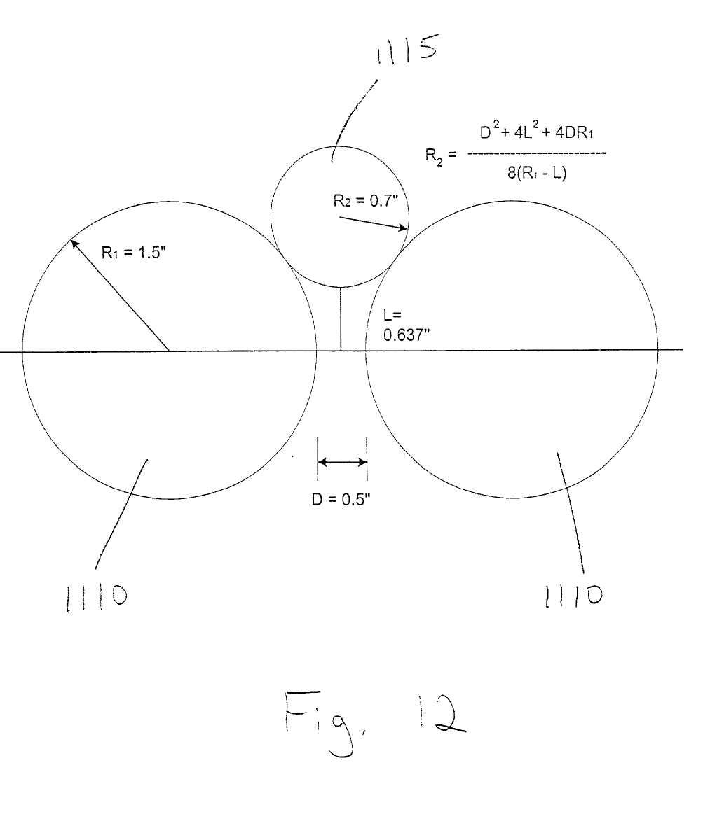

FIGS. 9 and 10 illustrate the operation of V gauge 900, in which rollers 910 form a guide portion for positioning work piece 925 with respect to sensor 905, which is configured to slide in and out of base 920. Arms 915 attach rollers 910 for rotation with respect to base 920. FIG. 9 illustrates a first position of V gauge 900 which is suitable for measuring work piece 925, having radius r₁. In this position, sensor 905 is extended to length L₁, arms 915 form angle θ₁ and rollers are separated by distance D₁. The measurements of L₁ and D₁ may be made with reference to any convenient origin. For example, as will be explained with reference to FIGS. 11 and 12, D₁ could be measured from the edges of rollers 910.

FIG. 10 illustrates a second position of V gauge 900 which is suitable for measuring relatively larger work piece 1025, having radius r₂>r₁. In this position, sensor 905 is retracted to length L₂, arms 915 have rotated to form angle θ₂ and rollers 910 are separated by distance D₂.

FIGS. 11 and 12 illustrate the theoretical basis for measurements using V gauge 900 or similar devices. Circles 1100, having radii R₁, correspond to rollers 910 of V gauge 900. Similarly, line 1105, having length L, corresponds with sensor 905 and circle 1115, having radius R₂, corresponds with work piece 925. When circles 1100 are in contact, radius R₂ of circle 1115 can be determined from L and R₁ using Equation 2:

$${R}_{2} = \frac{{L}^{2}}{2 ( {R}_{1} - L )} \qquad ( Equation 2 )$$

FIG. 12 illustrates the more general case wherein circles 1110 are not in contact, but instead are separated by a distance D. In this case, radius R₂ of circle 1115 can be determined from L, D and R₁ using Equation 3:

$${R}_{2} = \frac{{D}^{2} + 4 {L}^{2} + 4 {DR}_{1}}{8 ( {R}_{1} - L )} \qquad ( Equation 3 )$$

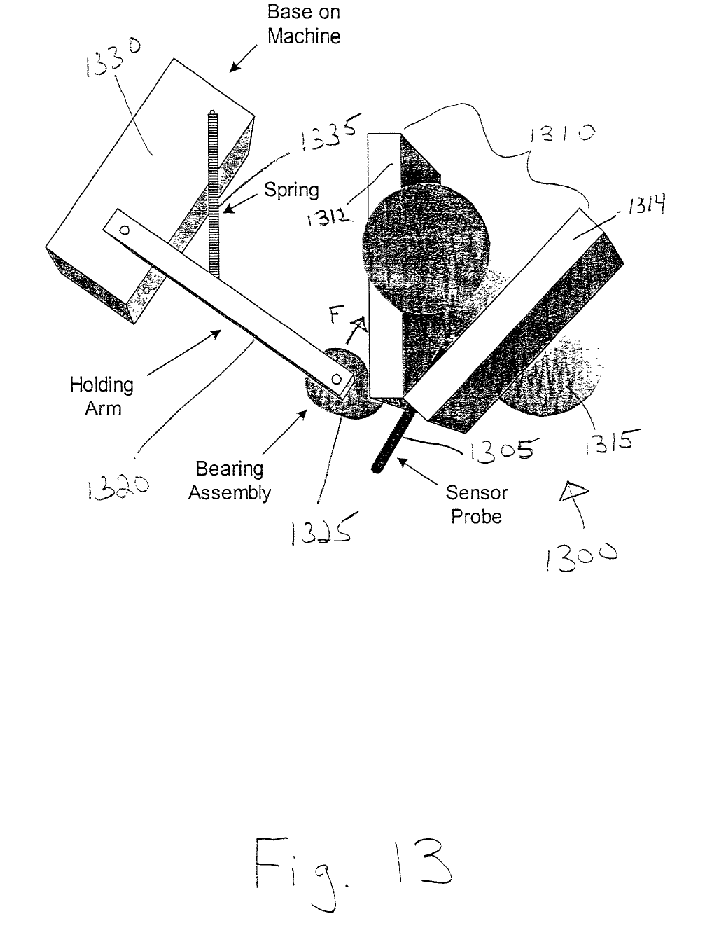

FIG. 13 is a schematic diagram of an embodiment of V gauge 1300, which is used in conjunction with a device for maintaining contact between V gauge 1300 and work piece 1315. Probe 1305 and guide portion 1310, which includes sides 1312 and 1314, are in contact with work piece 1315. Arm 1320 exerts force F through bearing assembly 1325, which allows V gauge 1300 to remain in contact with work piece 1315. Arm 1320 is attached for rotation to base 1330.

Spring 1335, which connects aim 1320 and base 1330, develops force F. In other embodiments, a variety of methods and devices are used to develop force F, including motors, pulleys, hydraulic or pneumatic devices, magnetic devices, gravity, connections (such as cables, wires or springs) between V gauge 1300 and work piece 1315 and elasticity in arm 1320. In the embodiment shown in FIG. 13, arm 1320 is attached to a machine for grinding or milling work piece 1315. However, in other embodiments, arm 1320 is attached elsewhere or is not used at all. For example, when force F is developed through a direct connection between V gauge 1300 and work piece 1315, arm 13 is not necessary. In such embodiments, the connection preferably includes a device which allows work piece 1315 to rotate freely, such as a ball bearing assembly.

Depending on the intended use, different probes may be employed. As noted above, some probes do not require physical contact with a work piece. However, a wide range of probes configured for physical contact with a work piece are within the scope of the present invention. For example, a probe that is physically wide in the axis of the work piece would perform well for a grinding operation where the area that is being machined is also wide.

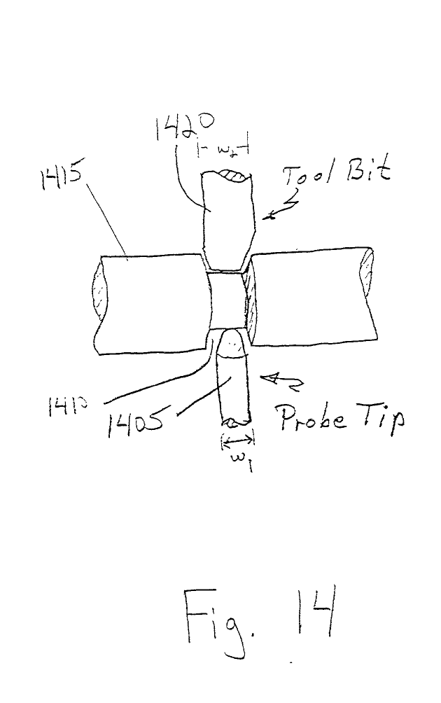

However, when a probe is used in a machining operation such as lathing, it will be necessary for the probe tip to be on the order of the size of the tip of the lathe's tool bit the probe is to make the radius measurement without a significant lag. Such a probe is illustrated in FIG. 14. Probe 1405 is situated within groove 1410, which has been cut into work piece 1415 by tool bit 1420. It is advantageous for probe tip 1405 to have a width w₁ which is on the order of width w₂ of tool bit 1420; otherwise, the measurement of probe tip 1405 will be of an area other than the area being machined. For precise measurements, it is generally preferable for width w₁ to be less than width w₂, as shown in FIG. 14.

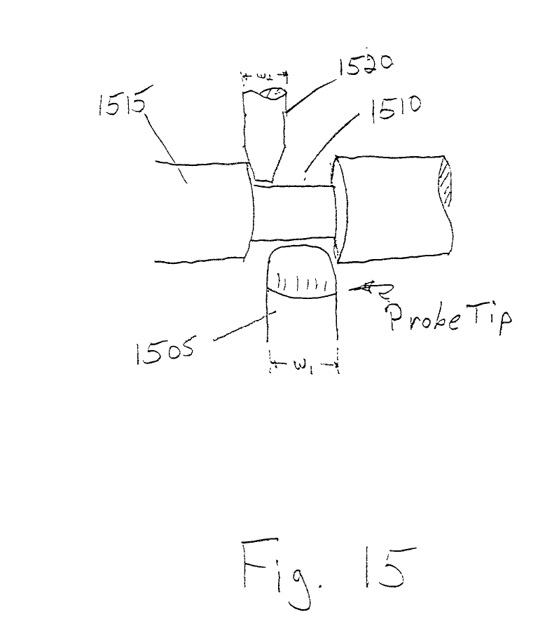

For some applications, however, it is acceptable for a probe tip to be wider than the tool bit, as shown in FIG. 15. There, probe 1505 is situated within groove 1510, which has been formed in work piece 1515 by tool bit 1520. Probe tip 1505 has a width w₁ which is greater than width w₂ of tool bit 1520 and therefore probe tip 1505 is shown to be measuring an area other than the area currently being machined by tool bit 1520. Such an arrangement may be acceptable if, for example, relatively less precision is required for the measurement of groove 1510. It is also acceptable for probe tip 1505 to be wider than tool bit 1520 when tool bit 1520 removes material from groove 1510 at a predictable rate and probe tip 1505 is used in connection with a timing device, such that the depth of groove 1510 may be both directly measured by probe tip 1505 and also calculated, based upon the predictable rate.

There are two general methods of measuring a machined area such as groove 1410 or groove 1510. In the first method, both the probe and the guide portion of the V gauge are within the machined area. In this method, the guide portion needs to be narrow enough to enter the machined area for the same reason previously stated in the probe discussion. When using this method, the V gauge will “ride” the machined area as it is being machined and thereby make accurate, real-time measurements. The first method is also less affected by axial misalignment since the guide portion and the probe contact three points which are roughly along the circumference of the same cross-section of the work piece.

In the second general method, the guide portion of the V gauge rides on an area of the work piece which is not being machined. In this method, the measured radius will not be accurate without modifying the r/L formula. Since the probe will extend into the machined area but the Vee will not, it will then be reading backward without this modification. An example of use in this mode would be to set the guide portion Vee on the work piece prior to machining it and then measure the diameter of the work piece. Then, the V gauge would be switched to “cutting” mode, for example by switching polarity control 335 of V gauge 300. Then, the radius of the machined area is calculated to be increasing with an increased probe length. According to one such embodiment, the increasing probe length is divided by two and subtracted from the original measured diameter. This mode is most amenable to electronic or optical sensors but purely mechanical versions can be devised as well.

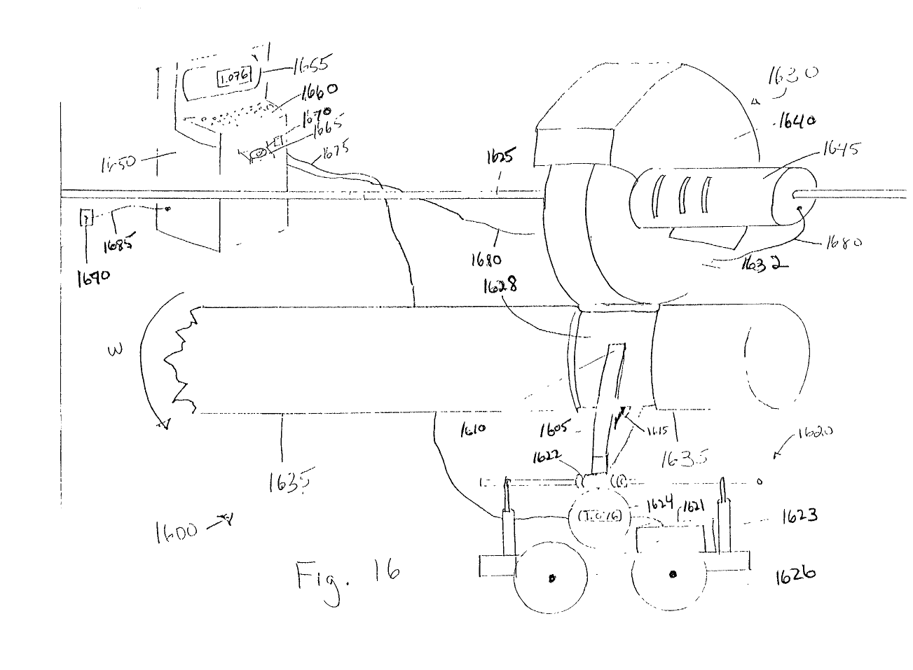

FIG. 16 is a simplified drawing of automated control system 1600, in which V gauge 1605 is used in a feedback loop for machining articles to size without operator intervention. The features of FIG. 16 are not drawn to scale. Moreover, control system 1650 appears small because it is in the background.

Positioning device 1620 is propelled by motor 1621, under the control of control system 1650, as needed to move V gauge 1605 to measure various portions of work piece 1635. V gauge 1605 includes sides 1610, within which machined portion 1628 of work piece 1635 is situated. Sensor 1615 measures machined portion 1628. In this embodiment, V gauge 1605 includes gauge 1624, which indicates the diameter of machined portion 1628.

V gauge 1605 also sends a signal to control device 1650 that indicates the measurements of sensor 1615. In the embodiment of automated control system 1600 shown in FIG. 16, signals are sent between control device 1650 and V gauge 1605 via cable 1675. However, in other embodiments, signals are sent and received via wireless devices and cable 1675 is unnecessary. In this embodiment, the diameter of machined portion 1628 is shown on display 1655.

Control device 1650 includes keyboard 1660 for accepting input, including data and commands, from a user. Optical disk drive 1665 allows data to be read from optical disk 1670. In some embodiments, optical disk drive 1665 has both data reading and writing capabilities, which allows information to be read from or written to optical disk 1670. In some embodiments, control device 1650 includes storage device 1668, which comprises a hard drive in the embodiment depicted in FIG. 16. Other embodiments of control device 1650 include additional drives, such as floppy disk drives or remote storage via a LAN.

In some embodiments of the present invention, optical disk 1670 is used to deliver a computer program to control device 1650. In some embodiments of the present invention, optical disk 1670 is used to deliver information to be used with a program which has already been installed on control system 1650. Such information could include, for example, data regarding a particular work piece, instructions for a manufacturing operation or specifications for a desired product.

In some embodiments of the present invention, control device 1650 is connected to a network such as the Internet, an intranet, etc. In the embodiment shown in FIG. 16, control system 1650 is connected to a network via line 1685, which connects control system 1650 with wall jack 1690. In other embodiments, control device 1650 is connected to a network using a wireless connection. In some networked embodiments, information is transmitted to control device 1650 over the network. In some such embodiments, specifications, programs and other information are downloaded to control device 1650 from the Internet. In some such embodiments, a user may send commands to control device 1650, receive status reports including measurements from V gauge 1605 regarding the progress of a manufacturing operation, etc. In one embodiment, a user sends commands to control device 1650 from a remote personal computer. In another embodiment, a user sends commands to control device 1650 from another control device 1650.

Positioning device 1620 maintains contact between V gauge 1605 and machined portion 1628 by applying force via supports 1623. In this embodiment, supports 1623 include a hydraulic piston and cylinder mechanism that is controlled by control system 1650. After machined portion 1628 has been machined to a desired condition, control device 1650 causes supports 1623 to retract and motor 1621 to drive wheels 1626 until V gauge 1605 is in position to measure the next machined portion.

Grinder 1630, which is controlled by control system 1650, includes grinding wheel 1632, hood 1640 and motor 1645. In the embodiment shown in FIG. 16, signals are sent between control device 1650 and grinder 1630 via cable 1680. However, in other embodiments, signals are sent and received via wireless devices. Grinder 1630 grinds work piece 1635, which is being rotated at angular velocity c, until machined portion 1628 has been machined to a desired condition. Then, grinder 1630 is propelled by motor 1645 along rod 1625 as needed to shape work piece 1635 in various locations, according to commands from control device 1650.

In other embodiments, different types of machining devices are controlled by automated control system 1600. For example, the lathe tool bits 1420 and 1520 of FIGS. 14 and 15, respectively, may be controlled by automated control system 1600. In some embodiments, several machining tools are simultaneously machining one or more work pieces, and a V gauge is used to monitor the progress of each tool. In this way, several aspects of a manufacturing operation can proceed in parallel.

FIG. 17 is a block diagram that illustrates a simplified relationship between V gauge assembly 1710, controller 1720 and machine tool assembly 1730 in automated control system 1700. V gauge 1710 sends measurement signals to controller 1720, which may be disposed within a device such as control device 1650, within a V gauge assembly, within a machining device or within a computer connected with V gauge assembly 1710 and machine tool assembly 1730 via a network. Controller 1720 typically includes one or more processors and related hardware and firmware (for example, BIOS and a CMOS chip) and is normally controlled by a software program which is customized for a particular application. Such software may reside, for example, on storage device 1668 of control device 1650.

The measurement signals transmitted by V gauge 1710 will vary according to the type of probe used and the specific embodiment of the V gauge. In many embodiments, the measurement signals will correspond to the length of a probe such as sensor 1615 of FIG. 16. In other embodiments, a V gauge will send a measurement signal corresponding to a calculated dimension of a work piece, for example the radius of a work piece. In still l other embodiments, the measurement signals will correspond to the raw output of a non-contact sensor, such as a voltage, a capacitance, an impedance, a time value, etc.

Controller 1720 controls V gauge assembly and machine tool assembly 1730 according to the measurement signals received from V gauge 1710 and according to information which is stored in controller 1720, in storage device 1668 of control device 1650, or which is otherwise accessible by controller 1720. Such information may include, for example, a formula or look-up table for determining a dimension of a work piece from an input measurement signal or data regarding a desired diameter for a machined portion of a work piece.

When the measurement signals from V gauge assembly 1710 indicate that the machined portion has reached a desired condition, controller 1720 will send control signals instructing machine tool assembly 1730 to stop machining the machined portion. In some embodiments, when there are additional areas of the work piece to be machined, controller 1720 will send commands instructing machine tool assembly 1730 and/or V gauge assembly 1710 to move to a different portion of the work piece.

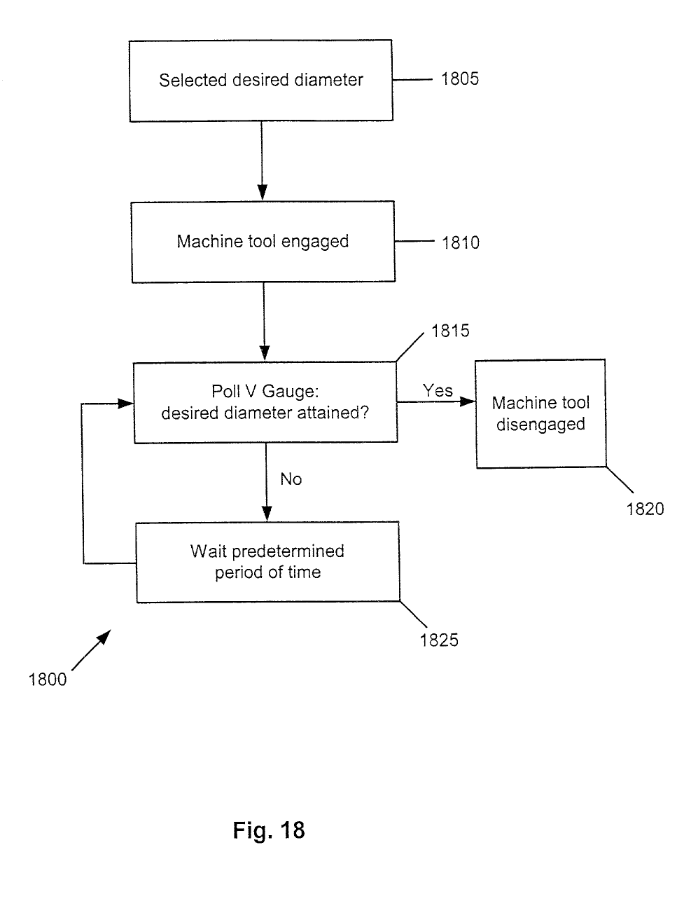

FIG. 18 is a flow chart that outlines subroutine 1800 for an automated control system such as depicted in FIGS. 16 and 17. In step 1805, a user selects a desired diameter for a machined portion of a work piece. In other embodiments, the dimensions of the work piece are input from an optical disk, input from a networked computer, downloaded from the Internet, etc., and no user selection is required.

In step 1810, a machine tool is engaged with the work piece, e.g., by a command from controller 1720 and/or control device 1650. In step 1815, a V gauge is polled to determine whether the machined portion has been machined to the selected diameter. If not, in step 1825 a predetermined time interval elapses before the V gauge is polled again. This period of time may be varied to fit an expected time until completion of a particular task. For example, when it typically takes 15 minutes to grind a particular material to a desired diameter, the polling interval may be relatively long at first (for example, 1 minute) and then may gradually decrease as the anticipated time to completion approaches (for example to one second). When the desired diameter is reached, the machine tool is disengaged from the work piece.

In some embodiments, a modified version of subroutine 1800 is used to engage a series of machine tools with one or more work pieces, then poll multiple V gauges until a plurality machined portions have attained a plurality of selected diameters. In other embodiments, V gauges are not polled, but continuously send measurement signals to a processor or control device.

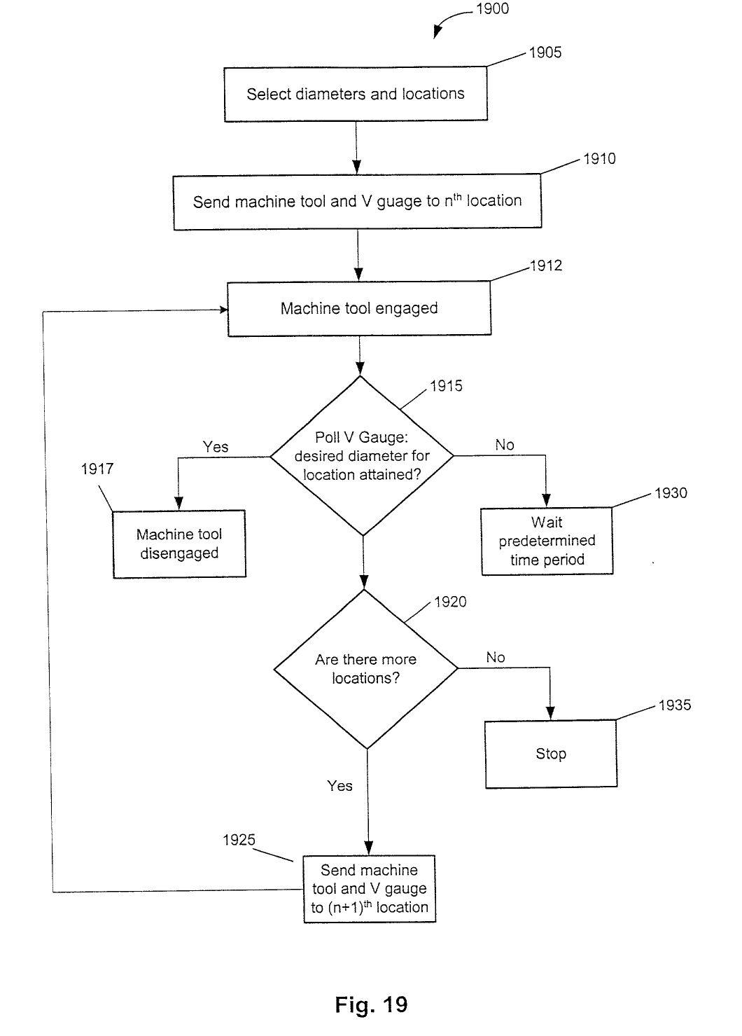

FIG. 19 is a flow chart that outlines subroutine 1900 for an automated control system such as depicted in FIGS. 16 and 17. In step 1905, multiple diameters and locations of machined portions of one or more work pieces are selected. In step 1910, a machine tool (such as grinder 1630) and a V gauge (such as V gauge 1605) are moved to a first location to be machined and in step 1912 the machine tool is engaged with the work piece. Beginning with step 1915, the V gauge is polled to determine whether a desired diameter is attained for the first machined portion. If not, in step 1930 a predetermined time elapses before the V gauge is polled again. As in subroutine 1800, the time periods may vary or the V gauge may, in the alternative, continuously send measurement signals to a processor or control device.

When the desired diameter for the machined portion has been attained, the machine tool is disengaged in step 1917 and in step 1920 it is determined (e.g., by controller 1720) whether there are more locations which need machining. If so, in step 1925 the machine tool and V gauge are sent to the next location and in step 1912 the machine tool is engaged with the work piece at the next location. Steps 1915 and 1930 are repeated until the desired diameter of the machined portion is reached. When, in step 1920, it is determined that there are no more locations which need to be machined, the process stops in step 1935.

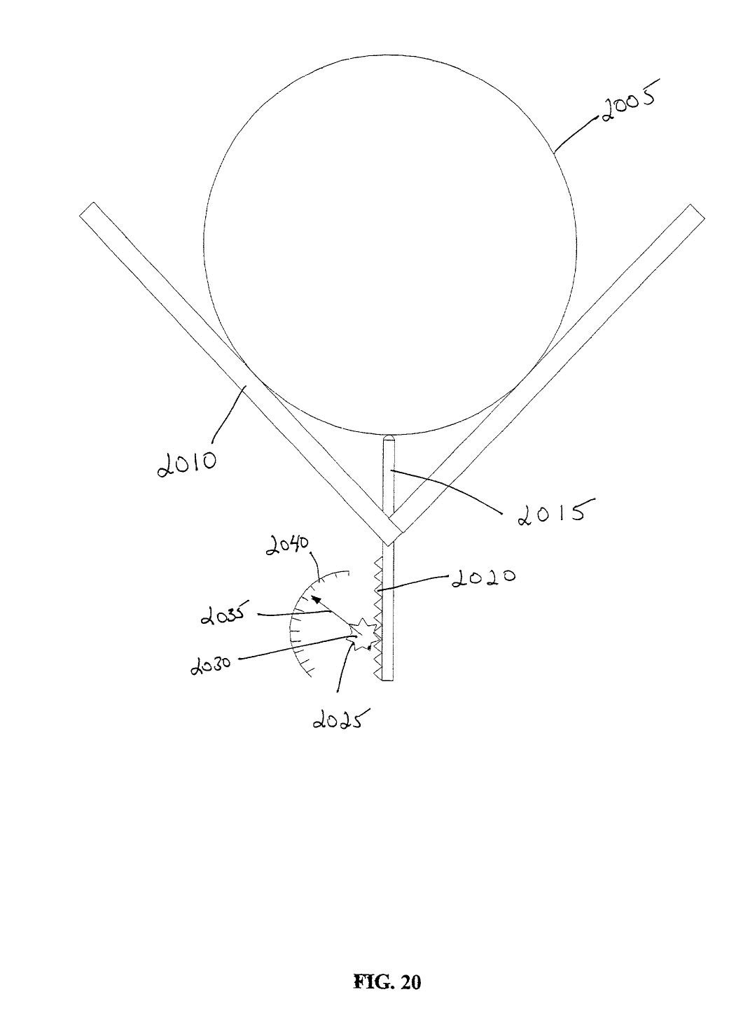

One embodiment of a coupling between a gauge portion and a probe is illustrated in FIG. 20. This embodiment is advantageous for V gauges having probes which are in physical contact with a work piece. Work piece 2005 is in contact with sides 2010 and probe 2015. When probe 2015 is moved upward or downward to accommodate a larger or smaller radius, teeth 2020 of probe 2015 engage with recesses 2025 of gear 2030, thereby moving pointer 2035 with respect to dial 2040.

Alternative V gauge embodiments include those in which the sensor is fixed and one or both sides of the guide portion are movable. In some fixed-sensor embodiments, a fixed blade is used in place of the movable sensor described for other embodiments. In some such embodiments, the blade is at right angles to the work piece axis. In some embodiments, the measurement of work piece diameter would be the distance the two Vees were moved apart when the work piece makes contact with the blade. In some embodiments, the sides of the guide portion are moved with a scissor action and a radius is measured based on the angle between the sides when the blade and the sides are contacted by the work piece.

Other types of V gauges are designed for the convenient measurement of a sphere. Some such V gauges include a guide portion with conical elements. At least four contact points are needed for these V gauges, rather than the three needed to measure a cylinder.

In addition to its utility in measuring the radius or diameter of a cylinder having a circular cross-section, a Vee gauge can also be used to measure a cylinder having an elliptical cross-section. As noted above, the ellipsisity of such a cylinder may be measured by recording the maximum and minimum recorded radii as it the V gauge is moved around the cylinder (or as the cylinder spins when the V gauge is fixed). In a similar way, a V gauge can locate the major and minor axes of the cylinder.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiments, it is to be understood that his disclosure is only illustrative and exemplary of the present invention and is made merely for purposes of providing a full and enabling disclosure of the invention. The foregoing disclosure is not intended or to be construed to limit the present invention or otherwise to exclude any such other embodiment, adaptations, variations, modifications and equivalent arrangements, the present invention being limited only by the claims appended hereto and the equivalents thereof.

I claim:

1. A device for measuring an object, at least part of which has a substantially circular cross-section, the device comprising:
a guide portion for contacting a first point and a second point of the object, the first and second points being separated by an arc of less than 180 degrees along a circumference of the object; and
a probe for measuring a distance between a point of reference and a third point of the object lying between the first and second points.

2. A device according to claim 1, further comprising means for determining a radius of the object based on the distance and the separation of the first and second points.

3. A device according to claim 1, further comprising means for determining a diameter of the object based on the measured distance and the separation of the first and second points.

4. A device according to claim 1, further comprising means for determining a circumference of the object based on the measured distance and the separation of the first and second points.

5. A device according to claim 1, further comprising means for determining a cross-sectional area of the object based on the measured distance and the separation of the first and second points.

6. A device according to claim 1, wherein the guide portion comprises a first side and a second side.

7. A device according to claim 1, wherein the probe measures the distance by contacting a surface of the object.

8. A device according to claim 1, wherein the probe measures the distance without contacting a surface of the object.

9. A device according to claim 6, wherein the first side is configured to move with respect to the second side.

10. A device according to claim 6, wherein the first side comprises a first substantially planar surface, the second side comprises a second substantially planar surface and the first and second substantially planar surfaces define a first angle.

11. A device according to claim 9, wherein the first side and the second side have substantially circular cross-sections.

12. A device according to claim 10, wherein the first side further comprises a third substantially planar surface, the second side further comprises a fourth substantially planar surface and the third and fourth substantially planar surfaces define a second angle.

13. A device according to claim 11, wherein the first side is configured to rotate with respect to a first axis and the second side is configured to rotate with respect to a second axis.

14. A device according to claim 12, wherein the first side further comprises a third substantially planar surface, the second side further comprises a fourth substantially planar surface and the third and fourth substantially planar surfaces define a second angle.

15. A device for measuring an object, at least a portion of which has a substantially circular cross-section, comprising:
means for contacting a first point and a second point of the object, the first and second points being separated by an arc of less than 180 degrees along a circumference of the object;
means for measuring a distance between a reference point and a third point of the object lying between the first and second points; and
means for determining a dimension of the object based on the measured distance and the separation of the first and second points, wherein the dimension is proportional to a radius of the object.

16. A device according to claim 15, wherein the measuring means contacts the object when taking a measurement.

17. A device according to claim 15, wherein the measuring means does not contact the object when taking a measurement.

18. A device according to claim 15, wherein the measuring means comprises rolling means for contacting the object when taking a measurement.

19. An automated control system for shaping a work piece, comprising:
a V gauge for measuring a machined portion of the work piece and for generating measurement signals;
a machining device for shaping the machined portion; and
a control device for controlling the machining device according to the measurement signals.

20. The automated control system of claim 19, wherein the V gauge comprises a guide portion and a probe.

21. The automated control system of claim 20, wherein the guide portion contacts the machined portion when the machining device is shaping the machined portion.

22. The automated control system of claim 20, wherein the guide portion contacts a portion of the work piece adjacent to the machined portion when the machining device is shaping the machined portion.

23. A measuring device, comprising:
a first component comprising a first flat surface;
a second component comprising a second flat surface, wherein the first flat surface and the second flat surface are separated by an angle α₁;
a sensor for measuring a distance L to the surface of an object having a radius r when the object's surface is simultaneously in contact with the first flat surface and the second flat surface; and
a converter for converting a measurement of L to radius r based on the mathematical relationship
$$\frac{r}{L} = \frac{sin ( {α}_{1} / 2 )}{1 - sin ( {α}_{1} / 2 )} .$$

24. The measuring device of claim 23, wherein the sensor comprises a device for measuring L without contacting the object.

25. The measuring device of claim 23, wherein the sensor comprises a probe which makes contact with the object when the sensor measures distance L.

26. The measuring device of claim 23, further comprising a motor for translating the first component with respect to the second component while maintaining the angle α₁ between the first flat surface and the second flat surface.

27. The measuring device of claim 23, wherein:
the first component further comprises a third flat surface;
the second component further comprises a fourth flat surface, the third flat surface and the fourth flat surface being separated by an angle α₂; and
the converter converts a measurement of L to radius r based on the mathematical relationship
$$\frac{r}{L} = \frac{sin ( {α}_{2} / 2 )}{1 - sin ( {α}_{2} / 2 )} .$$

28. The measuring device of claim 23, further comprising a display for indicating the radius.

29. The measuring device of claim 23, further comprising:
means for computing a diameter of the object; and
a display for indicating the diameter.

30. The measuring device of claim 23, further comprising:
means for computing a cross-sectional area of the object; and
a display for indicating the cross-sectional area.

31. The measuring device of claim 25, wherein the probe comprises a tip which is configured to roll when making contact with a moving object.

32. A method of measuring a dimension of an object, at least a portion of which has a substantially circular cross-section, comprising the steps of:
contacting a first point of the object with a first side of a measuring device;
contacting a second point of the object with a second side of the measuring device, the first and second sides of the measuring device being separated by an angle and the first and second points being separated by an arc of less than 180 degrees along a circumference of the object;
measuring a distance from a reference point to a third point of the object disposed between the first and second points; and
calculating the dimension based on the angle and the distance.

33. The method of claim 32, wherein the dimension is a radius.

34. The method of claim 32, wherein the dimension is a diameter.

35. The method of claim 32, wherein the dimension is a cross-sectional area.

36. The method of claim 32, wherein the dimension is a circumference.

37. The method of claim 32, wherein the dimension is an axis of an ellipse.
